(19) United States
(12) Patent Application Publication
(10) Pub. No.: US 2025/0050709 A1
(43) Pub. Date: Feb. 13, 2025

(54) A HIGH VOLTAGE FLUID HEATER (HVCH)

(71) Applicant: Valeo India Private Limited, Chennai (IN)

(72) Inventors: Rohan Rajamaran, Chennai (IN); Mathivanan Marappan, Chennai (IN); Nikhil Reddy Nalla, Chennai (IN)

(73) Assignee: Valeo India Private Limited, Chennai (IN)

(21) Appl. No.: 18/720,658

(22) PCT Filed: Dec. 15, 2022
(86) PCT No.: PCT/IN2022/051075

§ 371 Date: Jun. 17, 2024

(30) Foreign Application Priority Data
Dec. 18, 2021 (IN) 202141059202

(51) Int. Cl. B60H 1/22

(52) U.S. Cl. CPC B60H 1/2221

(57) ABSTRACT

A high voltage fluid heater includes a housing that includes at least one of walls and openings along different sides of the housing to define at least one enclosure. The housing also includes an inlet and an outlet for fluid to flow into and out of the housing. The heater also includes a printed circuit board along a first plane along one side of the housing, a heating element controlled by the printed circuit board, a power transistor assembly including a plurality of power transistors, at least one thermal pad along a side wall of the housing, and at least one spring element. Each power transistor includes a plurality of lead frames emanating from the transistor and adapted to be connected to the printed circuit board. The fluid heater also includes a spring element adapted to be mounted on the housing.

### TECHNICAL FIELD

The present invention relates to a heat exchanger. In particular, the present invention relates to high voltage fluid heater for a motor vehicle.

### BACKGROUND

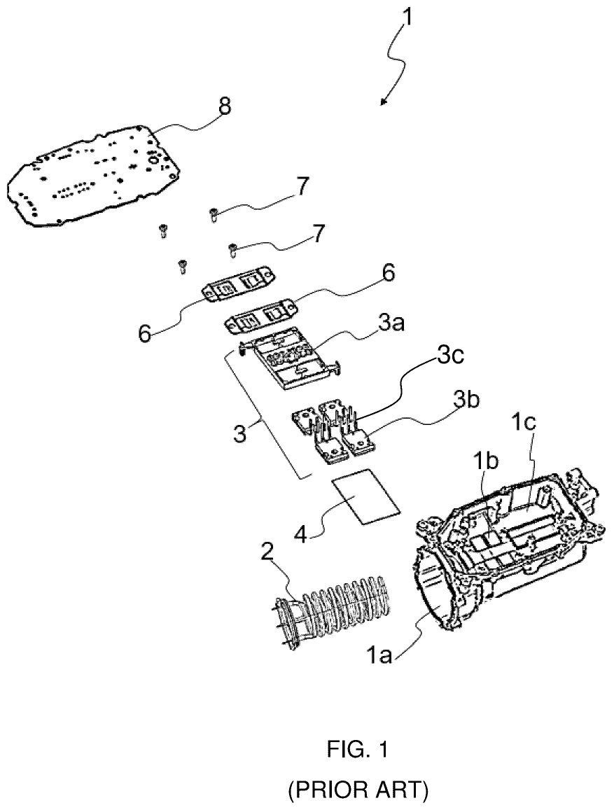

A high voltage fluid heater, particularly, high voltage coolant heater (HVCH), hereinafter referred to as HVCH generally used for either one of passenger cabin heating and improving battery energy performance in electric and hybrid vehicles by offering battery thermal management, particularly, consistent temperature distribution inside a battery pack and its cells. The HVCH is generally used for heating a fluid, for example, a coolant. The fluid heated by the HVCH is circulated through a fluid conduit network, wherein such fluid conduit network either in conjunction with an air conditioning loop is used for cabin heating or such fluid conduit network in conjunction with a battery thermal management system is used for improving battery performance. FIG. 1 of the accompanying drawings illustrates a HVCH 1. The HVCH 1 generally includes a housing 1a, a heating element 2, a power transistor assembly 3, a thermal pad 4, at least one spring element 6, a plurality of bolts 7 and a printed circuit board, hereinafter referred to as PCB 8. The insulated power transistor assembly 3 can be a gate bipolar transistor (IGBT) assembly 3 or a metal oxide silicon field effect transistor (MOSFET), herein after broadly referred to as power transistor assembly 3

The housing 1a includes walls defining an enclosure to receive delicate electronic components such as the PCB 8, power transistor assembly 3 and Bus-bar assembly from the external environment. The housing 1b further includes removable covers disposed on sides thereof to provide access to the PCB 8 and the Bus bar assembly from different sides. The walls of the housing 1 further provide mounting surface on which the elements of the HVCH, such as for example, the power transistor assembly 3 and spring elements 6 are mounted. The at least one heating element 2, in the form of a heating coil, is received inside the housing 1a, particularly in a chamber defined by the housing 1a. The heating element 2 rejects thermal energy to the fluid, particularly, the coolant received inside the chamber and around the heating element 2 for heating of the coolant. The coolant heated by the heating element 2 flows through the network of fluid flow conduits that in conjunction with air-conditioning loop or battery thermal management system either achieves cabin heating or battery thermal management. The heating element 2 is generally in the form of a heating coil that is controlled by the PCB 8. The PCB 8 controls the heating element 2 based on output signal received by the power transistor 3.

The power transistor assembly 3 includes a holder, also referred to as power transistor holder 3a and a plurality of power transistors 3b that can either be IGBTs or MOSFETs. The power transistor 3b is a temperature based switch that receives input signal and selectively provides an output signal to the PCB 8 for controlling the heating element 30. The power transistors 3b are generally applicable in high voltage and high current applications and are prone to get heated during operation that may cause damage thereto. Accordingly, the power transistors 3b are required to be cooled for efficient operation thereof and enhancing the service life thereof. The power transistor 3b are generally cooled by urging against the housing 1a, particularly, the power transistors 3b are cooled by the fluid circulating across the conventional high voltage fluid heater 1. The power transistors 3b includes lead frames or pins 3c emanating therefrom and connected to the PCB 8 to the PCB 8. The power transistors 3b are held inside at least one power transistor holder 3a and are urged against corresponding flat platform portion 1b formed on an end wall 1c of the housing 1a, with corresponding thermal pad 4 disposed between the power transistor 3b and the corresponding platform portion 1b. More specifically, the spring elements 6 mounted on the housing 1a by means of bolts 7 urge the power transistor 6 against the flat platform portion 1b of the housing 1 with the thermal pad 4 disposed between the power transistors 3b and the corresponding flat portion 1b of the housing 1a. Such configuration of the power transistors 3b urged towards the end wall 1c enables cooling of the power transistors 3b through the fluid circulating across the high voltage fluid heater 1. The thermal pad 4 disposed between the power transistor 3b and the corresponding flat platform portion 1b further enhances the surface contact between the power transistor 3b and the flat platform portion 1b, as the power transistors 3b are urged against the flat platform portion 1b, thereby resulting in improved cooling of the power transistor through the fluid circulating in the conventional HVCH and improved heat dissipation from the power transistors 3b. With improved heat dissipation from the power transistors 3b, improved performance of the power module and better control of the heating element 2 by the PCB 8 achieved.

In case of the conventional HVCH 1, the PCB 8 is disposed along a first plane, whereas the power transistor assembly 3, the spring elements 6 are disposed along different planes parallel to the first plane. Particularly, the power transistor assembly 3, the thermal pad 4, the spring elements 6 are stacked one above the other in vertical direction, such an arrangement has drawbacks associated therewith. Particularly, the HVCH 1 extends along the height thereof, causing packaging issues along the height of the HVCH 1. Further, the bolt heads of the bolts 7 for mounting the power transistor assembly 3 to the end wall 1c of the housing 1a are directly underneath the PCB 8. The bolt heads being directly beneath the PCB 8, limits the creepage distance between bolt heads and the high voltage portions of the PCB 8. Accordingly, the chances of short-circuiting between the bolt heads of the bolts 7 and the high voltage portions of the PCB 8 is increased. Further, the lead frames or the pins 3c interconnecting the power transistors 3b to the PCB 8 require additional bending operation. Such bending of the lead frames not only increases the assembly time but also inherently increase spacing between the adjacent power transistors and further causing packaging issues inside the housing 1a.

Accordingly, there is a need for a HVCH that prevents the stacking of the components with respect to each other in one direction, thereby increasing the size of the HVCH in that direction, causing packaging issues along that side of the HVCH. Further, there is a need for a HVCH that addresses the problems arising due to limited creapage distance between high voltage portions of the PCB and bolt heads of bolts used for mounting the spring elements for urging the power transistors against the end wall of the housing. Furthermore, there is a need for a HVCH that prevents bending of the lead frames interconnecting the power transistors to the PCB, thereby preventing the drawbacks associated with the bending of the lead frames or pins of the power transistors.

An object of the present invention is to provide a HVCH that prevents stacking of the elements thereof with respect to each other in one direction or one side thereof, thereby obviating the problems caused by such arrangement.

Yet another object of the present invention is to provide a HVCH that addresses the packaging issues along one side thereof due to most of the elements stacked along one side of the HVCH and the HVCH extending along that side.

Another object of the present invention is provide a HVCH with sufficient creepage distance between PCB and bolt heads of bolts used for mounting power transistors to the housing and addressing problems arising due to insufficient creepage distance there-between.

Still another object of the present invention is to provide a HVCH with power transistor assembly so positioned relative to the other components that renders the HVCH compact.

Another object of the present invention is to provide a HVCH with power transistor assembly so positioned relative to the other components that bending of the lead frames or pins interconnecting power transistors of the power transistor assembly with a PCB is prevented.

In the present description, some elements or parameters may be indexed, such as a first element and a second element. In this case, unless stated otherwise, this indexation is only meant to differentiate and name elements which are similar but not identical. No idea of priority should be inferred from such indexation, as these terms may be switched without betraying the invention. Additionally, this indexation does not imply any order in mounting or use of the elements of the invention.

### SUMMARY

A high voltage fluid heater (HVCH), hereinafter referred to as HVCH, is disclosed in accordance with an embodiment of the present invention. The HVCH includes a housing, a printed circuit board (PCB), at least one heating element, a power transistor assembly, at least one thermal pad and at least one spring element. The housing includes at least one of walls and openings along different sides thereof to define at least one enclosure. The housing includes an inlet and an outlet for ingress and egress of fluid from inside the housing. The PCB is disposed along a first plane “A” along one side of the housing. The at least one heating element is controlled by the PCB. The power transistor assembly includes a plurality of power transistors. Each power transistor includes a plurality of lead frames emanating therefrom and connected to the PCB. The thermal pad is disposed along a side wall of the housing. The spring element is mounted on the housing to urge the power transistors against the thermal pad to enable cooling of the power transistors through the fluid circulating across the high voltage fluid heater. The power transistor assembly along with the thermal pad and the spring elements are disposed and extending along the side wall that is along a plane that is at an angle to the first plane A.

Generally, the housing includes a first cover that covers a first opening at a PCB side of the housing.

Further, the housing includes a second cover that covers a second opening at a bus-bar side of the housing disposed orthogonally to the PCB side of the housing.

Still further, the housing includes a third cover that covers a third opening at a power transistor side of the housing disposed orthogonally to the PCB side and the bus-bar side of the housing.

Further, the power transistor assembly includes at least one power transistor holder that holds the power transistors therein.

Specifically, each one of the power transistor assembly, the thermal pad and the spring element are disposed parallel to each other and are angularly disposed with respect to the first plane “A” of the PCB.

Particularly, the power transistor assembly is sandwiched between the thermal pad and the spring element.

In accordance with an embodiment of the present invention, the spring element includes multiple individual springs, each individual spring corresponding to a separate power transistor.

Preferably, the lead frames extend parallel to the power transistor assembly and are orthogonally connected to the PCB.

Generally, the lead frames includes a first section and a second section that is at an angle with respect to the first section, the first section is emanating and axially extending from the corresponding power transistor of the power transistor assembly whereas the second section is forming an orthogonal connection with the PCB.

In a preferred embodiment of the present invention, the side wall is disposed along a plane that is substantially orthogonal to the first plane (A), in particular, is orthogonal to the first plane (A), and the lead frames extending parallel to the power transistor assembly are orthogonally connected to the printed circuit board.

Generally, the High voltage fluid heater further includes an auxiliary housing that is angularly extending from the side wall and enclosing the power transistors.

Alternatively, the auxiliary housing orthogonally extending from the side wall and enclosing the power transistors.

Generally, the power transistor assembly is mounted to the housing by means of bolts. Each bolt includes a threaded shaft portion and a bolt head. The threaded shaft portion extends orthogonally to the side wall and the bolt head is enclosed within the auxiliary housing.

Specifically, the bolt head is facing a cover of the auxiliary housing.

More specifically, the threaded shaft portion passes through apertures on the spring element and engages with holes formed on the side wall with the thermal pad and the power transistors sandwiched between the spring element and the side wall.

Also is disclosed a method of assembling the HVCH as disclosed above. The method includes the step mounting the spring element on the side wall along a first direction “X” at an angle B to the first plane “A”, with the power transistor assembly and the thermal pad sandwiched between the spring element and the side wall. Subsequently, electrically connecting the lead frames emanating from the power transistors of the power transistor assembly to the PCB and extending along a second direction “Y” substantially parallel to the plane of the power transistors and at an angle C with respect to the printed circuit board.

### BRIEF DESCRIPTION

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates an exploded view of a conventional HVCH depicting the arrangement of the various elements thereof with respect to each other;

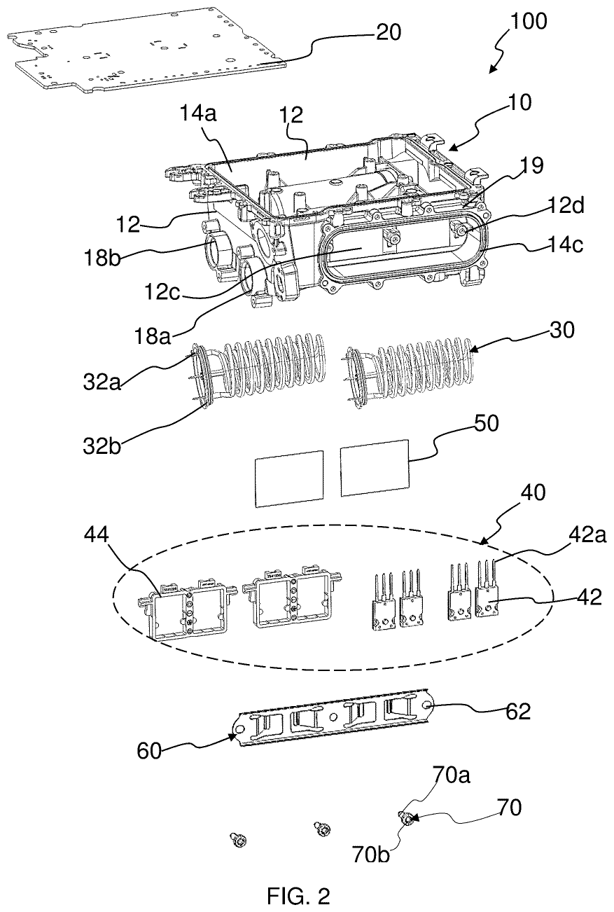

FIG. 2 illustrates an exploded view of a HVCH in accordance with an embodiment of the present invention depicting the arrangement of the various elements thereof with respect to each other;

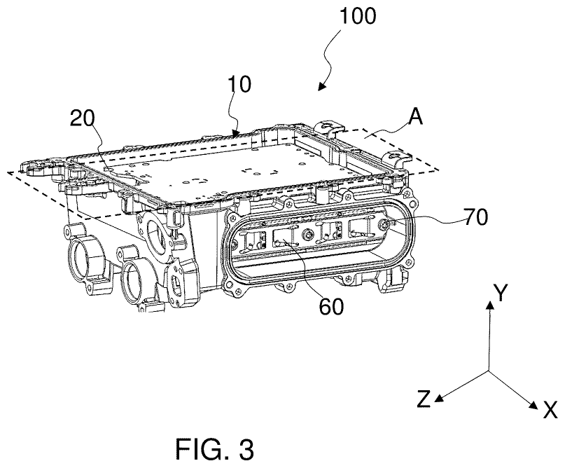

FIG. 3 illustrates an isometric view of the HVCH of FIG. 2 in an assembled configuration;

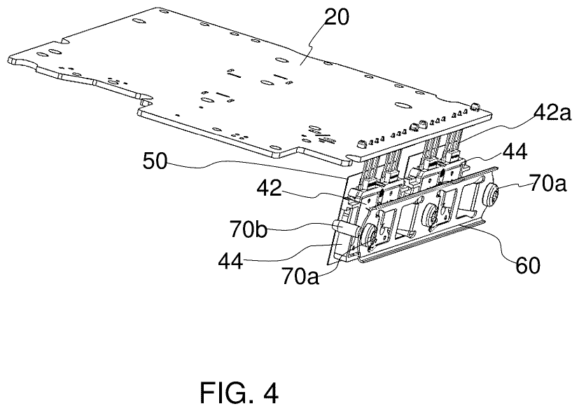

FIG. 4 illustrates an isometric view of an assembly of a PCB, a power transistor assembly, a pair of thermal pads and a spring element of the HVCH of FIG. 2, wherein the power transistor assembly, the pair of thermal pads and the spring element are disposed orthogonal to the PCB;

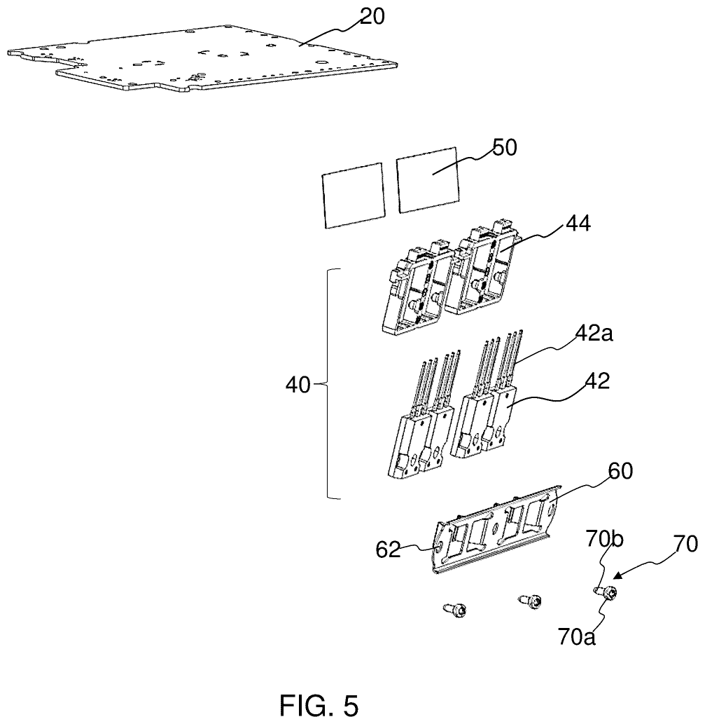

FIG. 5 illustrates an exploded view of the assembly of the PCB, the power transistor assembly, the pair of thermal pads and the spring element FIG. 4;

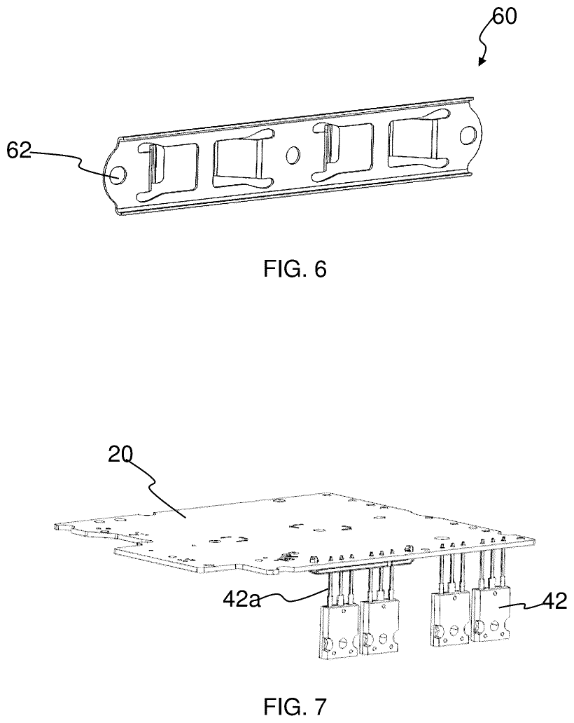

FIG. 6 illustrates the spring element of the HVCH of FIG. 2;

FIG. 7 illustrates arrangement of the power transistors of the power transistor assembly with respect to the PCB of the HVCH of the FIG. 2, wherein lead-frames or pins emanating from the power transistors are orthogonally connected to the PCB;

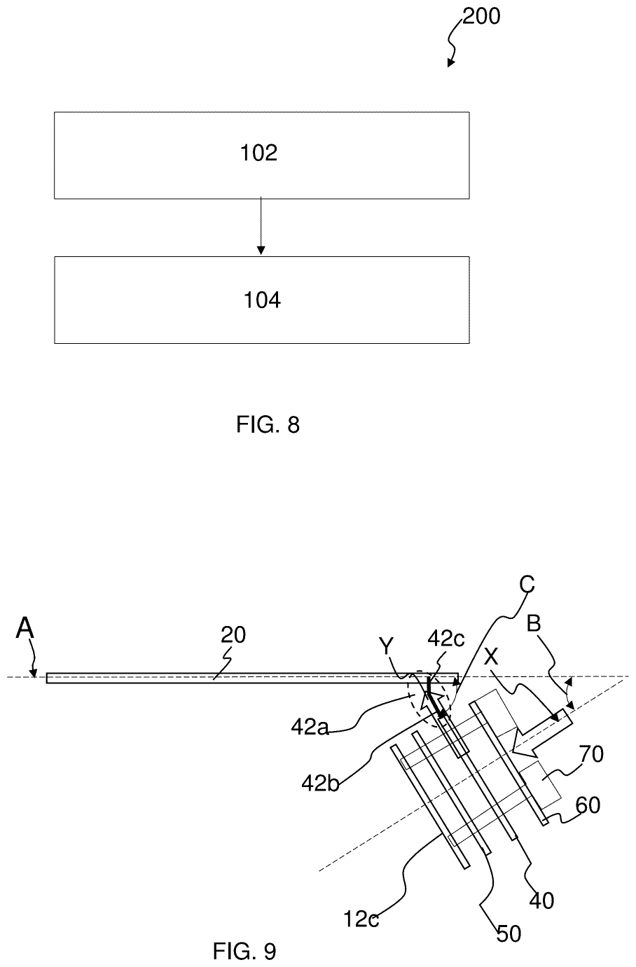

FIG. 8 illustrates a block diagram depicting the steps involved in the method for assembling the HVCH; and

FIG. 9 illustrates a schematic representation depicting interaction between various elements of a HVCH in accordance with another embodiment, wherein the side wall is at an angle with respect to the first plane “A”.

It must be noted that the figures disclose the invention in a detailed enough way to be implemented, said figures helping to better define the invention if needs be. The invention should however not be limited to the embodiment disclosed in the description.

### DETAILED DESCRIPTION

Although the present invention is explained with example of HVCH, wherein the elements of the HVCH, particularly, an IGBT assembly, hereinafter broadly referred to as a power transistor assembly, a thermal pad and a spring element are arranged parallel to each other and along a plane that is angularly disposed with respect to a printed circuit board, preferably, along a plane that is substantially orthogonal to a printed circuit board, referred to as PCB, instead of being stacked parallel to a planar surface of the PCB. Such arrangement of the elements of the HVCH prevents the HVCH from extending along a direction orthogonal to the PCB, particularly along the height of the HVCH and addresses the packaging issues along the height of the HVCH. Further, such arrangement of the power transistor assembly and spring element relative to the PCB addresses other problems arising due to insufficient creepage distance between high voltage portions of the PCB and bolt heads of bolts used for mounting the spring element to the housing and problems due to bending of the lead-frames interconnecting the power transistors to the PCB when power transistor assembly is disposed parallel to the PCB. However, the present invention is not limited to HVCH and is applicable to any heat exchanger or PCB controlled devices used in vehicular and non-vehicular applications that uses power transistors and it is required to package such heat exchanger/PCB controlled device in a limited space while still addressing problems due to insufficient creepage distance between PCB and mounting bolts and problems due to bending of lead-frames or pins of the power transistor.

FIG. 2 illustrates an exploded view of a HVCH 100 in accordance with an embodiment of the present invention. The HVCH 100 includes a housing 10, a printed circuit board (PCB) 20, at least one heating element 30, a power transistor assembly 40, at least one thermal pad 50 and at least one spring element 60. The HVCH 100 further includes a plurality of bolts 70 for mounting the power transistor assembly 40 to the housing 10. More specifically, the bolts 70 urge power transistors 42 of the power transistor assembly 40 towards the flat platform portion formed on a side wall 12c of the housing 10, thereby improving heat dissipation from the power transistors 42 and improving performance of the power transistor and achieving better control of the heating element 30 by the PCB 20.

The housing 10 includes at least one wall 12a, 12b, 12c, 12d and 12e with opening 14a, 14b and 14c along different sides 10a, 10b, 10c and 10d of the housing 10 to define at least one enclosure accessible through the openings. The housing 10 includes a PCB side 10a, a bus-bar side 10b, a power transistor side 10c, along with other sides. The housing 10 further includes at least one chamber for receiving the corresponding heating element 30. The chamber further receives the fluid to be heated, particularly the coolant to be heated, around the heating element 30. In accordance with one embodiment, the housing 10 includes a first chamber receiving a first heating element therein and a second chamber for receiving a second heating element therein. Further, the housing 10 includes an inlet 18a for ingress of fluid inside the first chamber and an outlet 18b for egress of fluid from the second chamber. The first chamber and the second chamber are inter-connected to each other to define fluid flow path around the heating elements and between the inlet 18a and the outlet 18b. More specifically, the fluid entering the housing 10 through the inlet 18a flows sequentially through the first chamber and the second chamber, around the first and second heating elements and egresses through the outlet 18b after extracting heat from the heating element 30. However, the number and placement of the heating elements 30 inside the housing 10 and the flow passaged configured and followed by the fluid inside the housing 10 can be of different configuration.

The PCB side 10a, the bus-bar side 10b and the power transistor side 10c side are orthogonal to each other. The PCB side 10a includes a first opening 14a that is closable by a first cover. The first cover can be secured to the PCB side 10a by using screws and is removable to provide access to the PCB 20. Similarly, the bus bar side 10b includes a first auxiliary housing enclosing the bus bars, the first auxiliary housing includes a second opening closable by a second cover being removable to provide access to the bus bar. The bus-bars configure bus bar connections. Further, the power transistor side 10c of the housing 10 includes a second auxiliary housing 19 with a third opening 14c closable by a third cover being removable to provide access to the power transistor assembly 40. The first, the second and the third covers protect the delicate electronic elements, particularly, the PCB 20, the bus bars and the power transistor assembly 40 respectively against the external environment conditions such as dust and moisture.

The PCB 20 is disposed along a first plane “A” along the PCB side 10a of the housing 10. The PCB 20 include a plurality electronic components mounted thereon, wherein at least one of the components mounted on the PCB 20 is a high voltage element. Insufficient creepage distance between the high voltage element of the PCB 20 and other conductive/grounded elements such as the bolts 70 for mounting the power transistor assembly 40 to the housing 10 can cause short-circuit between the high voltage elements of the PCB 20 and the bolts 70. The bolts 70 being threadably engaging with the side wall 12c of the housing 10 are grounded indirectly grounded via the housing 10. The creepage distance is length of shortest path followed by current to reach a conductive/grounded element. The HVCH 100 of the present invention addresses the problems arising due to insufficient creepage distance between the high voltage elements of the PCB and the bolts, as faced in conventional arrangement, by mounting the power transistor assembly 40 angularly with respect to the PCB 20, preferably orthogonal to the PCB 20. Further, the auxiliary housing 19 encloses the power transistor assembly 40 and the bolts 70 used for mounting the power transistor assembly 40 to the housing 10 therein, thereby further increasing the creepage distance between the high voltage elements of the PCB 20 and the bolts 70. In such configuration, the bolt head of the bolts 70 used for mounting the power transistor assembly 40 to the housing 10 are at sufficient creepage distance with respect to PCB 20 and short-circuiting between the high voltage portions of the PCB 20 and the bolts 70 is avoided. Particularly, such configuration prevents the problem of insufficient creepage distance between the high voltage elements of the PCB 20 and the mounting bolts in case of conventional arrangement of the conventional HVCH, wherein the mounting bolts are just beneath the PCB and the creepage distance between the two is insufficient for preventing short-circuiting.

The at least one heating element 30 is in the form of a heating coil that is received inside the housing 10, particularly, inside the chamber of the housing 10 and is controlled by the PCB 20. Each heating element 30 includes a positive terminal 32a and a negative terminal 32b extending outside the housing 10 and defining a current flow path there-between.

The power transistor assembly 40 includes the plurality of power transistors 42 held within at least one power transistor holder 44. The power transistor 42 is a temperature based switch that receives input signal and selectively provides an output signal to the PCB 8 for controlling the heating element 30. The power transistors 42 are generally applicable in high voltage and high current applications and are prone to get heated during operation that may cause damage thereto. Accordingly, the power transistors 42 are required to be cooled for efficient operation thereof and enhancing the service life thereof. The power transistor 42 are generally cooled by urging against the housing 10, particularly, the power transistors 42 are cooled by the fluid circulating across the high voltage fluid heater 100. The power transistor holder 44 includes a plurality of frame structures corresponding to the number of power transistors 42 to be held thereby. Each frame structure receives and firmly holds therein the corresponding power transistor 42 in position to prevent any displacement of the power transistors 42. Each power transistor 42 includes a plurality of lead frames 42a emanating therefrom and connected to the PCB 20. As the power transistor assembly 40 along with the power transistors 42 are disposed orthogonally to the PCB 20, the lead frames 42a extending from top edge of the power transistors 42, parallel to the power transistor assembly 40 are orthogonally connected to the PCB 20. With such configuration, particularly, orthogonal arrangement of the power transistor assembly 40 with respect to the PCB 20, the bending of the lead frames 42a interconnecting the power transistors 42 to the PCB 20 is avoided. Accordingly, the lead frames 42a are orthogonally connected to the PCB 20 and bending of the lead frames 42a is avoided unlike the conventional HVCH 1, wherein the power transistors of the power transistor assembly are disposed parallel to the PCB and the lead frames are required to be bend at right angle to configure connection with the PCB. With such configuration, the power transistors 42 can be arranged close to each other inside the second auxiliary housing 19 of the housing 10 and can be packaged within limited space inside the second auxiliary housing 19 of the housing 10. The power transistor assembly 40 is mounted to the housing 10 by means of the bolts 70. Each bolt 70 includes a threaded shaft portion 70a and a bolt head 70b. The threaded shaft portion 70a extends orthogonally to the side wall 12c and engages with the holes 12d on the side wall 12c, whereas the bolt head 70b is enclosed within the second auxiliary housing 19. Specifically, in case of the HVCH 100 of the present invention, the threaded shaft portion 70a of the bolt 70 passes through apertures 62 formed on the spring element 60 and engages with holes 12d formed on the side wall 12c with a thermal pad 50 and the power transistors 42 sandwiched between the spring element 60 and the side wall 12c as the spring element 60 is mounted on the side wall 12c. The bolt 70 extends substantially parallel to the PCB 20 as the bolt 70 is being deployed to mount the spring 60 to the side wall 12c of the housing 10, More specifically, the bolt head 70b is facing a cover of the second auxiliary housing 19 unlike the conventional arrangement of mounting the power transistor assembly with respect to the PCB in case of the conventional HVCH 1, wherein the bolts for mounting the power transistor assembly to the housing are directly beneath the PCB.

The thermal pad 50 is disposed along the side wall 12c of the housing 10. The thermal pad 50 is having a laminar construction and is secured to the flat platform portion of the side wall 12c of the housing 10. The thermal pad 50 disposed between the power transistor 42 and the corresponding flat platform portion formed on the side wall 12c further improves the surface contact between the power transistor 42 and the flat platform portion formed on the side wall 12c as the power transistors 42 are urged towards the flat platform portion formed on the side wall 12c by the spring element 60. Specifically, the thermal pad 50 improves contact between the power transistors 42 and the housing 10. Accordingly, the thermal pad 50 improves cooling of the power transistor 42, thereby enhancing the performance of the power transistors 42 and resulting in better control of the heating element 30 by the PCB 20.

The spring element 60 is mounted on the housing 10 with the power transistor assembly 40 and the thermal pad 50 disposed between the spring element 60 and the housing 10. The spring element 60 includes a planar portion with openings formed thereon and resilient portions extend across the openings to urge the power transistor 42 against the thermal pad 50. The spring element 60 urges the power transistors 42 against the thermal pad 50 to enable improved cooling of the power transistors 42 through the fluid circulating across the high voltage fluid heater 100, particularly, by the fluid flowing inside the chambers. More specifically, the power transistor 42 is urged against the side wall 12c, wherein the side wall 12c is cooled by the fluid flowing inside the chambers defined by the housing 10 and the power transistor 42 being urged against the side wall 12c is cooled by the side wall 12c. Accordingly, resulting in improved heat dissipation from the power transistors 42 and improving performance of the power transistor 42 for achieving improved control of the heating element 30 by the PCB 20. In a preferred embodiment, the thermal pad 50 is disposed along the side wall 12c of the housing 10 that is proximal to the inlet 18a that receives the coolant, thereby further improving the cooling of the power transistors 42 for achieving better performance of the power transistor 42 and achieving better control of the heating element 30 by the PCB 20. In accordance with an embodiment of the present invention, the spring element 60 includes multiple individual springs, each individual spring corresponding to the separate power transistor 42. More specifically, each spring of the of the spring element 60 urges the corresponding power transistor 42 towards the side wall 12c of the housing 10 with the thermal pad 50 between the power transistor 42 and the side wall 12c, when the spring element 60 is mounted on the housing 10 by means of the bolts 70.

The power transistors assembly 40 along with the thermal pad 50 and the spring element 60 are disposed and extend along the side wall 12c of the housing 10 that is disposed along a plane that is angularly disposed with respect to the first plane, preferably, the side wall 12c is substantially orthogonal to the first plane “A”. Although, the side wall 12c can be disposed along a plane that is angularly disposed with respect to the PCB 20 as illustrated in FIG. 9, however, the present invention is explained based on a preferred embodiment of the present invention, wherein the side wall 12c is disposed along plane that is orthogonal to the first plane “A”. In the preferred embodiment, the power transistor assembly 40, the thermal pad 50 and the spring element 60 are disposed parallel to each other and substantially orthogonal to the first plane “A” of the PCB 20. Particularly, the power transistor assembly 40 is sandwiched between the thermal pad 50 and the spring element 60. More specifically, the HVCH 100 includes an auxiliary housing 19, wherein walls of the auxiliary housing 19 are extending orthogonally from the side wall 12c of the housing 10 for receiving the power transistor assembly 40 and the thermal pad 50. In another embodiment, the wall of the auxiliary housing 19 are angularly extending from the side wall 12c of the housing 10. With such an arrangement of the power transistor assembly 40 with respect to the thermal pad 50 and the spring element 60, the power transistor assembly 40, the thermal pad 50 and the spring element 60 are all disposed on the side of the housing 10 unlike the conventional HVCH 1, in which all these components are stacked parallel to the PCB, thereby increasing the overall height of the conventional HVCH 1. Although, the HVCH 100 of the present invention extends sideways but is compact along the height, thereby addressing the packaging issues along the height thereof. Angular configuration of the walls of the auxiliary housing 19 with respect to the side wall 12c of the housing 10, increases the creapage distance between the high voltage components of the PCB 20 and the bolts for mounting the power transistor assembly 40 to the side wall 12c of the housing 10.

Also is disclosed a method 200 of assembling the HVCH 100 as disclosed above in accordance with an embodiment of the present invention. FIG. 8 illustrates a block diagram depicting the various steps of the method 200 for assembling the HVCH 100. Particularly, the method further involves the steps of mounting the PCB 20, the spring element 60, the transistor assembly 40, the thermal pad 50 to the housing 10. The method 200 further involves the step of receiving the heating element 30 inside the housing 10 and electrically connecting the lead frames 42a emanating from the power transistors 42 of the power transistor assembly 40 to the PCB 20. Although, the various steps of the method 200 are depicted by blocks in the flow diagram and any number of steps described as method blocks can be combined in any order or can be performed in parallel to employ the method 200, or an alternative method. Additionally, individual blocks may be deleted from the flow chart depicting the method without departing from the scope and ambit of the present invention. The method 200 is to be understood with reference to the following description along with the FIG. 8.

Generally, the method includes the step of mounting the spring element 60 on the side wall 12c along a first direction “X” that is at an angle B to the first plane “A” as illustrated in FIG. 9, with the power transistor assembly 40 and the thermal pad 50 sandwiched between the spring element 60 and the side wall 12c. Subsequently, electrically connecting the lead frames 42a emanating from the power transistors 42 of the power transistor assembly 40 along a second direction “Y” substantially parallel to the plane of the power transistors 42 and at an angle C with respect to the printed circuit board 20, wherein the angle C can be either 90 degrees or any other angle between 0 to 180 degrees. In accordance with an embodiment of the present invention as illustrated in FIG. 9, angled lead frames 42a are used to connect PCB 20 and the power transistor 42 that is disposed at an angle w.r.t the PCB 20. Particularly, the lead frame 42a is having a first section 42b and a second section 42c, wherein the second section 42c is angularly disposed with respect to the first section 42b. The first section 42b axially extends from the power transistor 42 whereas the second section 42c is orthogonally connected to the PCB 20,

In case the spring element 60 is mounted along a side wall 12c that is disposed along a plane orthogonal to the first plane “A”, the method 200 includes step 102 of mounting the spring element 60 on the side wall 12c along a first direction “X” substantially parallel to the first plane “A”, with the power transistor assembly 40 and the thermal pad 50 sandwiched between the spring element 60 and the side wall 12c. Subsequently, the method involve step 104 of electrically connecting the lead frames 42a emanating from the power transistors 42 of the power transistor assembly 40 to the PCB 20 along a second direction “Y” substantially orthogonal to the first direction “X”.

In any case, the invention cannot and should not be limited to the embodiments specifically described in this document, as other embodiments might exist. The invention shall spread to any equivalent means and any technically operating combination of means.

1. A high voltage fluid heater comprising:
a housing comprising at least one of walls and openings along different sides thereof to define at least one enclosure,
the housing further comprising an inlet and an outlet for ingress and egress of fluid from inside the housing;
a printed circuit board disposed along a first plane along one side of the housing;
at least one heating element controlled by the printed circuit board;
a power transistor assembly comprising a plurality of power transistors,
each power transistor comprising a plurality of lead frames emanating therefrom and adapted to be connected to the printed circuit board;
at least one thermal pad disposed along a side wall of the housing;
at least one spring element adapted to be mounted on the housing to urge the power transistors against the thermal pad to enable cooling of the power transistors through the fluid circulating across the high voltage fluid heater,
wherein the power transistor assembly along with the thermal pad and the spring element are disposed and extending along the side wall that is along a plane at an angle to the first plane.

2. The high voltage fluid heater as claimed in claim 1,
wherein the housing comprises a first cover adapted to cover a first opening at a printed circuit board side of the housing.

3. The high voltage fluid heater as claimed in claim 2,
wherein the housing comprises a second cover adapted to cover a second opening at a bus-bar side of the housing disposed orthogonally to the printed circuit board side of the housing.

4. The high voltage fluid heater as claimed in claim 2,
wherein the housing comprises a third cover adapted to cover a third opening at a power transistor side of the housing disposed orthogonally to the printed circuit board side and the bus-bar side of the housing.

5. The high voltage fluid heater as claimed in claim 1,
wherein the power transistor assembly further comprises at least one power transistor holder adapted to hold the power transistors therein.

6. The high voltage fluid heater as claimed in claim 1,
wherein each one of the power transistor assembly, the thermal pad and the spring element are disposed parallel to each other and are angularly disposed with respect to the first plane “A” of the printed circuit board.

7. The high voltage fluid heater as claimed in claim 1,
wherein the power transistor assembly is sandwiched between the thermal pad and the spring element.

8. The high voltage fluid heater as claimed in claim 1,
wherein the lead frames extend parallel to the power transistor assembly and are orthogonally connected to the printed circuit board.

9. The high voltage fluid heater as claimed in claim 1,
wherein the lead frames comprises a first section and a second section at an angle with respect to the first section,
wherein the first section emanates and axially extends from the corresponding power transistor of the power transistor assembly whereas the second section forms an orthogonal connection with the printed circuit board.

10. The high voltage fluid heater as claimed in claim 1 ,
wherein the side wall is orthogonal to the first plane , and
wherein the lead frames extending parallel to the power transistor assembly are orthogonally connected to the printed circuit board.

11. The high voltage fluid heater as claimed in claim 1 ,
wherein the high voltage fluid heater further comprises an auxiliary housing angularly extending from the side-wall and enclosing the power transistors.

12. The high voltage fluid heater as claimed in claim 1 ,
wherein the auxiliary housing extends orthogonally from the side-wall and encloses the power transistors.

13. The high voltage fluid heater as claimed in claim 1 ,
wherein the power transistor assembly is mounted to the housing by means of bolts,
wherein each bolt comprises a threaded shaft portion and a bolt head,
wherein the threaded shaft portion extends orthogonally to the side wall and the bolt head is enclosed within the auxiliary housing.

14. A method of assembling the high voltage fluid heater according to claim 1, the method comprising:
mounting the spring element on the side wall along a first direction “X” at an angle B to the first plane “A”, with the power transistor assembly and the thermal pad sandwiched between the spring element and the side wall;
electrically connecting the lead frames emanating from the power transistors of the power transistor assembly to the printed circuit board and extending along a second direction “Y” substantially parallel to the plane of the power transistors and at an angle C with respect to the printed circuit board.
